(19) United States
(12) Patent Application Publication
(10) Pub. No.: US 2023/0082286 A1
(43) Pub. Date: Mar. 16, 2023

(54) THERMOSETTING COMPOSITE RESIN COMPOSITION IMPROVED IN SURFACE SMOOTHNESS AND SURFACE QUALITY, AND METHOD FOR MANUFACTURING MOLDED ARTICLE USING THE SAME

(71) Applicants: HYUNDAI MOTOR COMPANY, Seoul (KR); KIA CORPORATION, Seoul (KR); HANWHA SOLUTIONS CORPORATION, Seoul (KR)

(72) Inventors: Kyung Min Yu, Seoul (KR); Do Wan Lim, Sejong-si (KR); Gyu Nyeon Kim, Sejong-si (KR); Hyeon Kyu Lee, Sejong-si (KR)

(21) Appl. No.: 17/939,320

(22) Filed: Sep. 7, 2022

(30) Foreign Application Priority Data
Sep. 9, 2021 (KR) 10-2021-0120149

(51) Int. Cl. C08J 5/04; B29C 43/00; B29C 70/00; B29C 70/18

(52) U.S. Cl. CPC C08J 5/043; B29C 43/003; B29C 70/003; B29C 70/18; C08J 2367/00; B29K 2067/00

(57) ABSTRACT

Disclosed are a composite resin composition containing a thermosetting resin including an unsaturated polyester resin and a saturated polyester resin, a filler, and a processability-improving agent. More particularly, disclosed are a composite resin composition that is capable of providing a molded article having a lower specific gravity and improved surface quality compared to a conventional molded article by improving the compatibility and impregnability of a thermosetting resin and a filler using a processability-improving agent, and a molded article manufactured using the same.

### CROSS REFERENCE TO RELATED APPLICATIONS

This application claims under 35 U.S.C. § 119(a) the benefit of priority to Korean Patent Application No. 10-2021-0120149, filed on Sep. 9, 2021, the entire contents of which are incorporated herein by reference.

### BACKGROUND

### (a) Technical Field

The present disclosure relates to a composite resin composition containing a thermosetting resin including an unsaturated polyester resin and a saturated polyester resin, a filler, and a processability-improving agent. More particularly, the present disclosure relates to a composite resin composition that is capable of providing a molded article having a lower specific gravity and improved surface quality compared to a conventional molded article by improving compatibility and impregnability of a thermosetting resin and a filler using a processability-improving agent, and a molded article manufactured using the same.

### (b) Background Art

In general, an exterior automotive body plate is gel-coated fiber-reinforced plastic molded from a thermosetting resin composition through a hand lay-up process, and has problems of difficulty in securing uniform quality, discoloration, and insufficient rigidity due to the characteristics of the manufacturing method thereof and material therefor.

In order to solve these problems, a sheet-molding compound (SMC) molding process has recently been utilized in place of the hand lay-up process. The SMC molding process includes impregnating glass fibers with a thermosetting resin composition composed of an unsaturated polyester resin, a curing agent, and other conventional additives, and then heat-press molding the result with a hydraulic press.

Meanwhile, taking into consideration the fact that most of conventional patents relating to blended SMC materials disclose materials having high specific gravity, SMC material-related patents that enable the manufacture of molded articles having relatively low specific gravity have been proposed, but the molded articles obtained thereby are found to have new problems.

Korean Patent Laid-Open Publication No. 10-2019-0065245 relates to a thermosetting composite resin composition and a molded article manufactured therefrom through a sheet-molding compound (SMC) process. This patent is characterized in that a vehicle outer plate having low specific gravity can be produced, but still has the problem of poor coating quality due to poor surface quality.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is one object of the present disclosure to provide an SMC molded article having lower specific gravity compared to the prior art.

It is another object of the present disclosure to provide an SMC molded article having a low specific gravity as well as excellent coating quality owing to the superior surface quality of the material thereof.

It is another object of the present disclosure to provide an SMC molded article having improved impregnability.

The objects of the present disclosure are not limited to those described above. Other objects of the present disclosure will be clearly understood from the following description, and are able to be implemented by means defined in the claims and combinations thereof.

In one aspect, the present disclosure provides a composite resin composition containing a thermosetting resin, a filler, and a processability-improving agent.

The composite resin composition may contain a thickener, a fiber-reinforcing material, and an additive.

The composite resin composition may contain 22 to 28% by weight of the thermosetting resin, 34 to 40% by weight of the filler, 1 to 2% by weight of the processability-improving agent, 0.7 to 1.5% by weight of the thickener, 32 to 38% by weight of the fiber-reinforcing material, and 2 to 3% by weight of the additive.

The thermosetting resin may include an unsaturated polyester resin having a degree of unsaturation of 47 to 50%, and a saturated polyester resin including any one selected from the group consisting of epoxy, polyethersulfone (PES), polyvinyl acetate (PVAc), polyurethane (PU), and combinations thereof.

The filler may include any one selected from the group consisting of glass bubble, calcium carbonate (CaCO₃), aluminum hydroxide (Al(OH)₃), and combinations thereof.

The processability-improving agent may include one selected from the group consisting of acetates, acids, and combinations thereof.

The thickener may include a magnesium oxide powder (MgO paste).

The fiber-reinforcing material may include glass fibers.

The additive may include any one selected from the group consisting of a dispersant, an anti-separation agent, and a combination thereof.

In another aspect, the present disclosure provides a method of manufacturing a molded article including producing a sheet from the composite resin composition and pressing the sheet into a mold.

In another aspect, the present disclosure provides a molded article manufactured by the method, the molded article having a specific gravity of 1.30 or less, tensile strength of 70 MPa or more, a long waviness (LW) of 10 or less, and a combined factor (CF) of 68 or more.

### BRIEF DESCRIPTION OF THE FIGURES

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 illustrates the appearance of an SMC specimen manufactured in Example 1; and

FIG. 2 illustrates the appearance of an SMC specimen manufactured in Comparative Example 1.

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed context and to sufficiently inform those skilled in the art of the technical concept of the present disclosure.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures, and/or expressions. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

The present disclosure relates to a composite resin composition containing a thermosetting resin including an unsaturated polyester resin and a saturated polyester resin, a filler, and a processability-improving agent, a method of manufacturing a molded article using the composite resin composition, and a molded article manufactured by the method.

Hereinafter, each component contained in the composite resin composition of the present disclosure will be described, and the characteristics of the molded article manufactured using the composite resin composition will be described with reference to experimental examples and drawings.

### Composite Resin Composition

The composite resin composition of the present disclosure contains a thermosetting resin, a filler, and a processability-improving agent. Also preferably, the composite resin composition may further contain a thickener, a fiber-reinforcing material, and an additive.

### Thermosetting Resin

The thermosetting resin of the present disclosure includes an unsaturated polyester resin and a saturated polyester resin. Preferably, the thermosetting resin of the present disclosure includes an unsaturated polyester resin having a degree of unsaturation of 47 to 50% and a saturated polyester resin including one selected from the group consisting of epoxy, polyethersulfone (PES), polyvinyl acetate (PVAc), polyurethane (PU), and combinations thereof.

Any one may be used as the unsaturated polyester resin without any particular limitation, so long as it satisfies the degree of unsaturation, and the type thereof is not specifically limited in the present disclosure.

The thermosetting resin includes the unsaturated polyester resin and the saturated polyester resin at a weight ratio of 1:10 to 10:1.

The composite resin composition of the present disclosure contains 22% by weight to 28% by weight of the thermosetting resin. When the thermosetting resin is present in an amount less than 22% by weight, it may not be possible to produce a sheet due to insufficient impregnation, and when the thermosetting resin is present in an amount higher than 28% by weight, it may be difficult to lower the specific gravity of the molded article compared to the prior art due to the somewhat reduced content of the filler.

Filler

The filler of the present disclosure includes one selected from the group consisting of glass bubbles, calcium carbonate (CaCO₃), aluminum hydroxide (Al(OH)₃), and combinations thereof.

The composite resin composition of the present disclosure may contain 34% to 40% by weight of the filler. When the content of the filler is less than 34% by weight, the appearance of the molded product may be unsatisfactory, and when it exceeds 40% by weight, it may not be possible to produce a sheet.

### Processability-Improving Agent

The main features of the present disclosure are to lower the specific gravity of the molded article and improve the appearance by preventing impregnation defects from forming while increasing the content of the filler beyond that of the prior art. One component for implementing these features is a processability-improving agent.

The processability-improving agent of the present disclosure is a significant component configured to improve the compatibility of the unsaturated polyester resin with the filler contained in the thermosetting resin of the present disclosure. That is, the processability-improving agent improves the compatibility between the filler and the thermosetting resin and enhances impregnability, thereby maximizing the content of the filler, ultimately lowering the specific gravity of the molded product and improving the surface quality thereof.

The processability-improving agent includes one selected from the group consisting of acetates, acids, and combinations thereof.

The acetates preferably include acetates selected from the group consisting of n-butyl acetate, 2-methoxypropylacetate, 2-methoxy-1-methylethyl acetate, and combinations thereof.

The acids preferably include an acid selected from the group consisting of phosphoric acid, octadecanoic acid, fatty acids, and combinations thereof.

The processability-improving agent includes a reactive monomer that is capable of reacting with the unsaturated polyester, and the reactive monomer reacts with the unsaturated polyester resin contained in the thermosetting resin to improve compatibility between the unsaturated polyester and the filler.

The composite resin composition of the present disclosure contains 1% to 2% by weight of the processability-improving agent. When the processability-improving agent is present in an amount less than 1% by weight, the compatibility of the thermosetting resin and the filler cannot be improved, and when it is present in an amount higher than 2% by weight, it may be impossible to produce a molded article due to the lowered viscosity of the composite resin composition.

### Thickener

Any one may be used as the thickener without particular limitation, so long as it increases the viscosity of the composite resin composition to thereby convert the liquid composite resin composition into a semi-solid resin, and improve processability. The thickener may include MgO, Mg(OH)₂, CaO, Ca(OH)₂, and the like, and preferably may be magnesium oxide powder (MgO paste), which enables effective conversion into the semi-solid resin.

The composite resin composition of the present disclosure contains 0.7% to 1.5% by weight of the thickener.

### Fiber-Reinforcing Material

In the present disclosure, the physical properties of the molded article are deteriorated when maximizing the content of the filler so as to lower the specific gravity of the molded article and realize a high-quality appearance. For this reason, a fiber-reinforcing material may be essentially used in order to prevent a decrease in the rigidity of the molded product, and carbon fiber, boron fiber, glass fiber, etc. may be used, and glass fiber may be preferably used.

The composite resin composition of the present disclosure may contain 32% to 38% by weight of the fiber-reinforcing material. When the content of the fiber-reinforcing material is less than 32% by weight, the tensile strength of the molded article may be lowered, and when it exceeds 38% by weight, it may be impossible to produce a sheet due to the excessively added fiber-reinforcing material.

### Additive

Any one may be used as the additive without particular limitation so long as it can impart various functionalities, such as improving dispersibility and preventing separation, to the composite resin composition. The composite resin composition of the present disclosure may further contain an additive performing a required function, and may preferably contain one selected from the group consisting of a dispersant, an anti-separation agent, and combinations thereof.

The composite resin composition of the present disclosure may contain 2% to 3% by weight of the additive.

### Molded Article Manufacturing Method

The molded article of the present disclosure is produced in the same manner as a general method of manufacturing an SMC (sheet-molding compound) molded article. A composite resin composition is blended, extruded, and injected to prepare a sheet, and then the sheet is placed in a mold, followed by compression-molding to produce a molded article.

Preferably, the method for manufacturing a molded article of the present disclosure includes producing a sheet from a composite resin composition and pressing the sheet into a mold.

### Molded Article

A molded article is manufactured using the composite resin composition by the method for manufacturing a molded article of the present disclosure. The molded article thus manufactured has a specific gravity of 1.30 or less, a tensile strength of 70 MPa or more, a long waviness (LW) of 10 or less, and a combined factor (CF) of 68 or more. Here, LW is a numerical value of surface smoothness, determined through measurement of the wavelength reflected back on the surface. As the value decreases, the surface roughness of the material increases. CF is a surface quality value that is determined through a combination of major surface quality factors, namely gloss, clarity, and orange peel. As CF increases, the coating quality increases.

Hereinafter, the present disclosure will be described in more detail with reference to specific examples. However, the following examples are provided only for better understanding of the present disclosure, and thus should not be construed as limiting the scope of the present disclosure.

### Examples 1 to 4

A thermosetting resin, a filler, a thickener, a fiber-reinforcing material, other additives, and a processability-improving agent were mixed in the amounts shown in Table 1 below, and the resulting mixture was prepared into a sheet and then pressed into a mold to prepare the specimens of Examples 1 to 4.

TABLE 1

| | | Example | Example | Example | Example |
|---|---|---|---|---|---|
| Item | Criteria | 1 | 2 | 3 | 4 |
| Resin* | 22-28 | 23 | 22 | 22 | 22 |
| Filler* | 34-40 | 38 | 38.5 | 34 | 40 |
| Thickener* | 0.7-1.5 | 1 | 1 | 1 | 1 |
| Fiber-reinforc- | 32-38 | 33 | 33.5 | 38 | 32 |
| ing material* | | | | | |
| Other additives | 2-3 | 3 | 3 | 3 | 3 |
| Processability- | 1-2 | 2 | 2 | 2 | 2 |
| improving | | | | | |
| agent* | | | | | |

Resin: includes unsaturated polyester resin having degree of unsaturation of 50% and saturated polyester resin at a ratio of 1:1
Filler*: Calcium Carbonate
Thickener*: Magnesium Oxide Powder
Fiber-reinforcing material*: Glass fiber (Length: 1 inch)
Processability-improving agent*: includes n-butyl acetate and phosphoric acid at ratio of 1:1

### Comparative Examples 1 to 8

A thermosetting resin, a filler, a thickener, a fiber-reinforcing material, other additives, and a processability-improving agent were mixed in the amounts shown in Tables 2 and 3 below, and the resulting mixture was prepared into a sheet and then pressed into a mold to prepare the specimens of Comparative Examples 1 to 8. However, the materials for the respective components used in Comparative Examples were the same as those used in Examples.

TABLE 2

| | | Compara- | Compara- | Compara- | Compara- |
|---|---|---|---|---|---|
| | | tive Ex- | tive Ex- | tive Ex- | tive Ex- |
| Item | Criteria | ample 1 | ample 2 | ample 3 | ample 4 |
| Resin* | 22-28 | 31 | 25 | 21 | 21 |
| Filler* | 34-40 | 30 | 38 | 39 | 38 |
| Thickener* | 0.7-1.5 | 1 | 1 | 1 | 1 |
| Fiber- | 32-38 | 35 | 33 | 34 | 35 |
| reinforcing | | | | | |
| material* | | | | | |
| Other additives | 2-3 | 3 | 3 | 3 | 3 |
| Processability- | 1-2 | 0 | 0 | 2 | 2 |
| improving | | | | | |
| agent* | | | | | |

TABLE 3

| | | Compara- | Compara- | Compara- | Compara- |
|---|---|---|---|---|---|
| | | tive Ex- | tive Ex- | tive Ex- | tive Ex- |
| Item | Criteria | ample 5 | ample 6 | ample 7 | ample 8 |
| Resin* | 22-28 | 21 | 22 | 22 | 28 |
| Filler* | 34-40 | 40 | 33 | 41 | 33 |
| Thickener* | 0.7-1.5 | 1 | 1 | 1 | 1 |
| Fiber- | 32-38 | 33 | 39 | 31 | 33 |
| reinforcing | | | | | |
| material* | | | | | |
| Other additives | 2-3 | 3 | 3 | 3 | 3 |
| Processability- | 1-2 | 2 | 2 | 2 | 2 |
| improving | | | | | |
| agent* | | | | | |

### Measurement Method

Specific Gravity: ASTM D792

Fiber (G/F) content: weighing after burning and washing

Tensile Strength: ASTM D638

Appearance (LW, CF): LW and CF measurement using BYK Gardner's Wave scan DOI equipment

Coating adhesion: measured by forming horizontal and vertical cuts on the coating surface to the adherend at regular intervals with a cutter to produce blocks and counting the number of blocks on the coating surface that were damaged when a tape was attached to the blocks and then removed therefrom. The adhesion was determined based on the number of blocks that were detached among 100 blocks (10 horizontal lines×10 vertical lines) according to ISO 2409.

### Experimental Example

The physical properties of the specimens prepared in Examples and Comparative Examples were measured through the following measurement method, the quality thereof was evaluated, and the results are shown in Tables 4 to 6 below.

### Measurement Method

Specific Gravity: ASTM D792

Fiber (G/F) content: Weighing after burning and washing

Tensile Strength: ASTM D638

Appearance quality (LW, CF): LW and CF measurement were performed using BYK Gardner's Wave scan DOI

Coating adhesion: measured by forming horizontal and vertical cuts on the coating surface to the adherend at regular intervals with a cutter to produce blocks and counting the number of blocks on the coating surface that was damaged when a tape was attached to and then removed from the blocks. The adhesion was determined based on the number of blocks that were detached among 100 blocks (10 horizontal lines×10 vertical lines) according to ISO 2409.

TABLE 4

| Measurement | Example | Example | Example | Example |
|---|---|---|---|---|
| (evaluation) | 1 | 2 | 3 | 4 |
| Molding result | Good | Good | Good | Good |
| Fiber content | 33 | 33.5 | 38 | 32 |
| Specific gravity | 1.25 | 1.26 | 1.29 | 1.24 |
| Tensile strength | 71 | 70 | 75 | 70 |
| Specific strength | 56.8 | 55.6 | 58.1 | 56.5 |
| Surface quality LW | 5 | 8 | 9 | 6 |
| CF after coating | 72 | 70 | 68 | 69 |
| Coating adhesion | Good | Good | Good | Good |

TABLE 5

| | Compara- | Compara- | Compara- | Compara- |
|---|---|---|---|---|
| Measurement | tive Ex- | tive Ex- | tive Ex- | tive Ex- |
| (evaluation) | ample 1 | ample 2 | ample 3 | ample 4 |
| Molding result | Good | Good | Impregna- | Impregna- |
| Fiber content | 35 | 33 | tion | tion |
| Specific gravity | 1.35 | 1.25 | defects | defects |
| Tensile strength | 90 | 62 | | |
| Specific strength | 66.7 | 49.6 | | |
| Surface quality LW | 10 | 30 | | |
| CF after coating | 65 | 40 | | |
| Coating adhesion | Insufficient | Insufficient | | |

TABLE 6

| | Compara- | Compara- | Compara- | Compara- |
|---|---|---|---|---|
| Measurement | tive Ex- | tive Ex- | tive Ex- | tive Ex- |
| (evaluation) | ample 5 | ample 6 | ample 7 | ample 8 |
| Molding result | Impregna- | Impregna- | Impregna- | Surface |
| | tion | tion | tion | defects |
| Fiber content | defects | defects | defects | 33 |
| Specific gravity | | | | 1.32 |
| Tensile strength | | | | 84 |
| Specific strength | | | | 63.6 |
| Surface quality LW | | | | 23 |
| CF after coating | | | | 44 |
| Coating adhesion | | | | Unsatisfied |

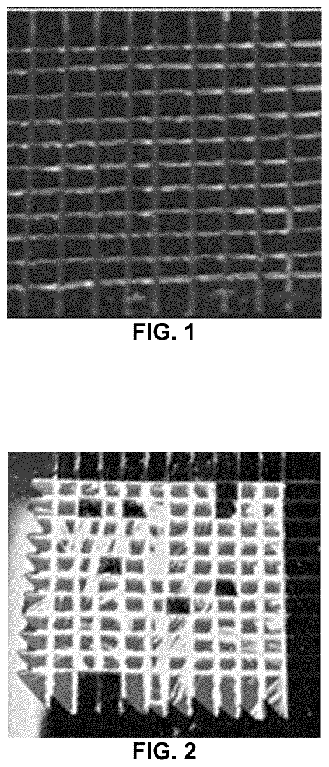

As can be seen from the results of Tables 4 to 6, all of Examples exhibited excellent coating adhesion, whereas all of Comparative Examples failed to satisfy the required levels. Representatively, the coating adhesion test results of Example 1 and Comparative Example 1 are shown in FIGS. 1 and 2. In FIG. 1 (illustrating coating adhesion of specimen of Example 1), no broken blocks were found, whereas in FIG. 2 (illustrating the coating adhesion of specimen of Comparative Example 1), almost all blocks were broken.

It can be seen that Comparative Examples 1 and 8 exhibited relatively high specific gravity, whereas all of the specimens of Examples exhibited low specific gravity below 1.30.

It can be seen in relation to impregnability that when the content of the thermosetting resin does not satisfy the required level of the present disclosure, impregnability is poor, and additionally that when the content of the fiber-reinforcing material or the filler does not satisfy the required level of the present disclosure, the impregnability is poor.

As is apparent from the foregoing, the present disclosure provides an SMC molded article having lower specific gravity compared to the prior art.

The present disclosure provides an SMC molded article having a low specific gravity as well as improved coating quality owing to the superior surface quality of the material thereof.

The present disclosure provides an SMC molded article having improved impregnability.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in the embodiments without departing from the principles and spirit of the present disclosure, the scope of which is defined in the appended claims and their equivalents.

1. A composite resin composition comprising:
a thermosetting resin;
a filler; and
a processability-improving agent.

2. The composite resin composition according to claim 1, comprising further comprising:
a thickener;
a fiber-reinforcing material; and
an additive.

3. The composite resin composition according to claim 2, wherein the composite resin composition comprises:
22 to 28% by weight of the thermosetting resin;
34 to 40% by weight of the filler;
1 to 2% by weight of the processability-improving agent;
0.7 to 1.5% by weight of the thickener;
32 to 38% by weight of the fiber-reinforcing material; and
2 to 3% by weight of the additive.

4. The composite resin composition according to claim 1, wherein the thermosetting resin comprises:
an unsaturated polyester resin having a degree of unsaturation of 47 to 50%; and
a saturated polyester resin including at least one of epoxy, polyethersulfone (PES), polyvinyl acetate (PVAc), polyurethane (PU), or any combination thereof.

5. The composite resin composition according to claim 1, wherein the filler comprises at least one of glass bubble, calcium carbonate (CaCO₃), aluminum hydroxide (Al(OH)₃), or any combination thereof.

6. The composite resin composition according to claim 1, wherein the processability-improving agent comprises at least one of acetate, acid, or any combination thereof.

7. The composite resin composition according to claim 6, wherein the processability-improving agent comprises the acetate and the acid.

8. The composite resin composition according to claim 6, wherein the acetate comprises at least one of n-butyl acetate, 2-methoxypropylacetate, 2-methoxy-1-methylethyl acetate, or any combination thereof.

9. The composite resin composition according to claim 6, wherein the acid comprises at least one of phosphoric acid, octadecanoic acid, fatty acids, or any combination thereof.

10. The composite resin composition according to claim 2, wherein the thickener comprises a magnesium oxide powder.

11. The composite resin composition according to claim 2, wherein the fiber-reinforcing material comprises glass fibers.

12. The composite resin composition according to claim 2, wherein the additive comprises at least one of a dispersant, an anti-separation agent, or any combination thereof.

13. A method of manufacturing a molded article comprising:
producing a sheet from the composite resin composition according to claim 1; and
pressing the sheet into a mold.

14. A molded article manufactured by the method according to claim 13, the molded article having a specific gravity of 1.30 or less, tensile strength of 70 MPa or more, a long waviness (LW) of 10 or less, and a combined factor (CF) of 68 or more.
